(19) United States
(12) Patent Application Publication
(10) Pub. No.: US 2015/0163576 A1
(43) Pub. Date: Jun. 11, 2015

(54) AUDIO SPEAKER POSITIONED IN DISPLAY SUPPORT AND/OR BASE

(71) Applicant: Lenovo (Singapore) Pte. Ltd., New Tech Park (SG)

(72) Inventor: Cuong Huy Truong, Cary, NC (US)

(73) Assignee: Lenovo (Singapore) Pte. Ltd., New Tech Park (SG)

(21) Appl. No.: 14/100,964

(22) Filed: Dec. 9, 2013

(51) Int. Cl. H04R 1/02

(52) U.S. Cl. CPC H04R 1/028; H04R 2499/15

(57) ABSTRACT

An apparatus includes a display, a base formed with at least one port, a support assembly connecting the display to the base, a speaker housing formed with ports, and at least one audio speaker in the speaker housing and positioned to direct sound through the ports of the speaker housing.

### FIELD

The present application relates generally to speakers provided on display devices.

### BACKGROUND

As displays and/or their assemblies become relatively thinner owing to advances in display technology to e.g. reduce the amount of space on (and/or above) a desk on which they are disposed, the available space for including other components and/or devices in such assemblies becomes greatly diminished. Even when other components can be included in and/or integrated with a display, the other components should be relatively small so that they may fit within the relatively smaller and/or thinner display. However, relatively smaller other components can in many cases limit the functionality, capability, quality, and/or robustness of such components.

### SUMMARY

Accordingly, in a first aspect an apparatus includes a display, a base formed with at least one port and a support assembly which connects the display to the base. The display is understood to be above the base. The apparatus also includes a speaker housing formed with ports. The speaker housing includes at least one audio speaker in the speaker housing which is positioned to direct sound through the ports of the speaker housing. The apparatus also includes at least one tube in the support assembly positioned to direct air to the port in the base.

In some embodiments, the support assembly may include a mounting plate engaged with the display. Also in some embodiments, the speaker housing may be on the base. The display may define a front surface which presents demanded images, and the base may define a front which faces the same direction as faced by the front surface of the display as well as a rear opposed to the front. The port in the base may be in the rear. In addition to the foregoing, the speaker housing may be cylindrical. The support assembly may include an upper arm segment pivotably connected to a lower arm segment to raise and lower the display.

In another aspect, an assembly includes at least one mounting surface to engage a display, a base to rest on a surface with the mounting surface above the base, a support assembly which movably interconnects the base and mounting surface, and at least one audio speaker positioned in at least one component selected from the group of the base and the support assembly.

In still another aspect, a method includes supporting a display on a movable support assembly above a base to which the support assembly is connected, providing at least one first port in the support assembly, providing at least one second port in the base, and providing a source of sound positioned to emit sound directly toward the first port.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of a system in accordance with present principles;

FIG. 2 is a side perspective view of a display support assembly and base in accordance with present principles;

FIG. 3, is rear perspective view of a display support assembly and base in accordance with present principles;

FIG. 4 is a bottom plan view of the base in accordance with present principles; and

FIG. 5 is a schematic cross-section of the speaker housing in accordance with present principles.

### DETAILED DESCRIPTION

This disclosure relates generally to device based and/or workstation based user information. With respect to any computer systems discussed herein, a system may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

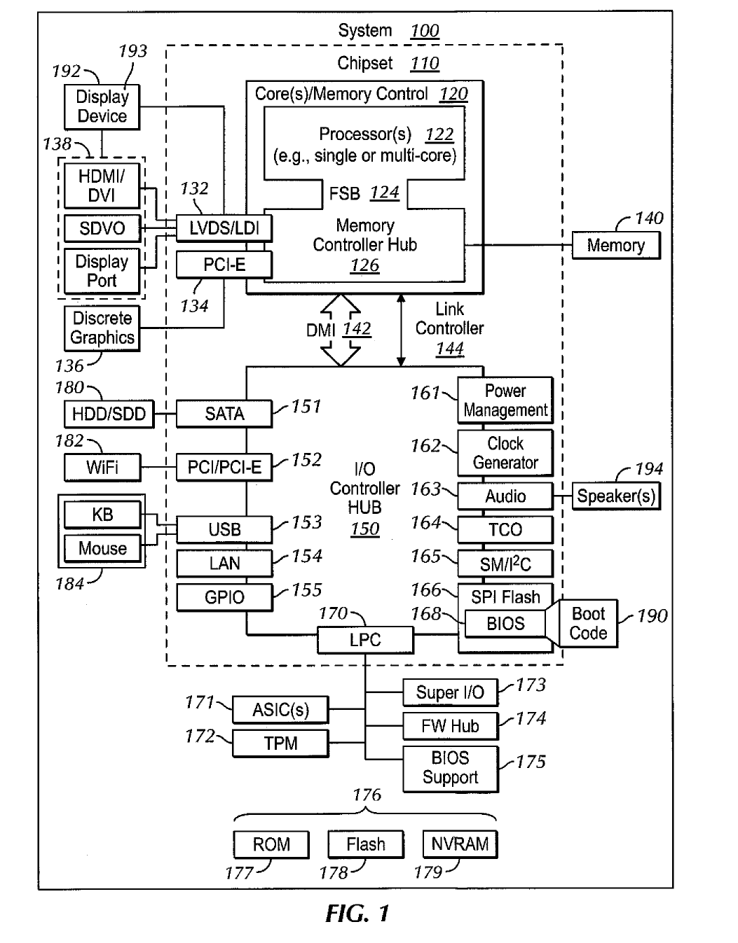

Now in reference to FIG. 1, a block diagram of an illustrative exemplary computer system 100 is shown. The system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory”.

The memory controller hub 126 further includes a low-voltage differential signaling interface (LVDS) 132. The LVDS 132 may be a so-called LVDS Display Interface (LDI) for support of a video display apparatus 192 (including, e.g., a CRT, a flat panel, a projector, etc.) including a front surface 193. A block 138 includes some examples of technologies that may be supported via the LVDS interface 132 (e.g., serial digital video, I-IDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card. An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface), a general purpose I/O interface (GPIO) 155, a low-pin count (LPC) interface 170, a power management interface 161, a clock generator interface 162, an audio interface 163 (e.g., for speakers 194), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes a basic input output system (BIOS) 168 and boot code 190. As used herein. “BIOS” can mean BIOS in the traditional sense and also the newer standard for BIOS/unified extensible firmware interface (UEFI).

With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. Again, as described herein, an exemplary client device or other machine may include fewer or more features than shown in the system 100 of FIG. 1.

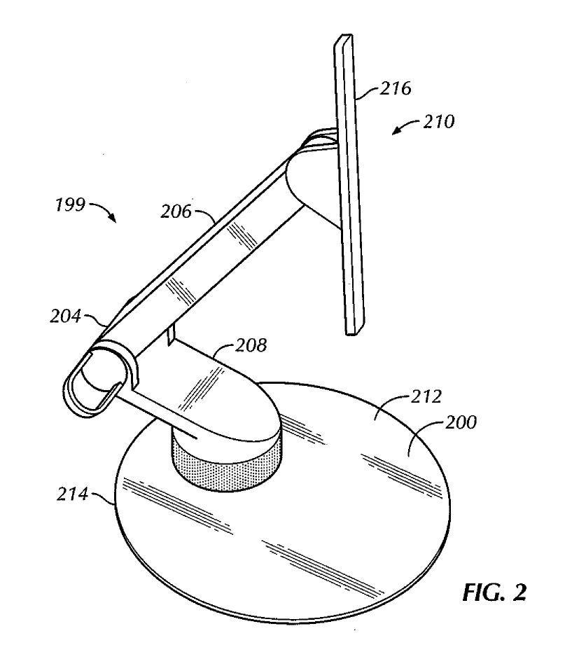

Now in cross-reference to FIGS. 2-5, these figures show an apparatus 199 (e.g. which may in some embodiments be a system such as the system 100 in which the display 192 includes and/or may be included with the apparatus 199). In any case, the apparatus 199 includes a base 200. The base 200 of the apparatus 199 may be formed with at least one port, hole, aperture, exit, opening, and/or vent 202 for e.g. sound (e.g. and/or sound vibrations and/or air vibrations) and air to travel and/or move from within the base 200 and out of the port(s) 202. The base 200 is understood to be configured to rest on a surface (e.g. a desk).

The apparatus 199 also includes a support assembly 204 which movably connects the display 192 to the base 200, it being understood that the display 192 is disposed above the base 200. It is to also be understood that the support assembly 204 may include an upper arm segment 206 pivotably connected to a lower arm segment 208 to raise and lower a mounting surface 210 such as e.g. a mounting plate for engaging the display 192. Thus, the segment 206 and segment 208 may be pivotably moved (e.g. relative to each other through a hinge pivotably connecting them) to raise and lower the display 192 when the display 192 is engaged with the mounting surface 210.

It is to be understood that the display 192 defines a front surface 193 (as generally shown in reference to FIG. 1 above) which presents images, and the base 200 defines a front 212 which faces (e.g. substantially) the same direction as faced by the front surface 193 of the display 192. The base 200 also includes a rear 214 of the base 200 opposed to the front 212. Accordingly, the mounting surface 210 for e.g. the display 192 is understood to also define a front surface 216, and thus the front 212 of the base 200 may face the same direction (e.g. or at least substantially the same direction) as faced by the front surface 216 and/or the front surface 193.

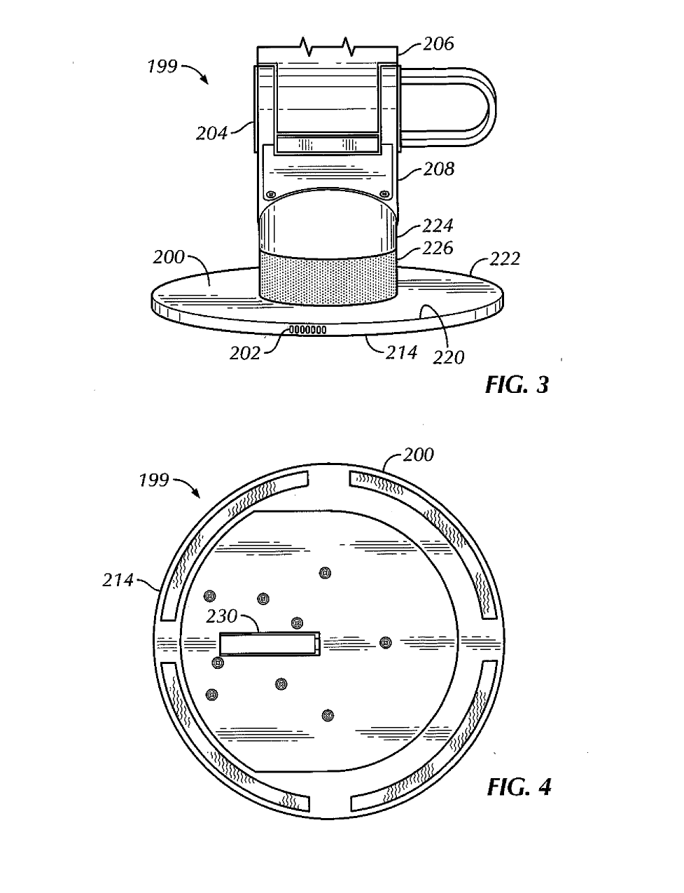

Further describing the rear 214 of the base 200 and the ports 202 both discussed above, in addition to the rear 214 being opposed to the front 212, note that in exemplary embodiments the rear 214 in particular may include the e.g. plural ports 202. However, it is to be understood that the ports 202 in other embodiments may be positioned on the base 200 at portions other than the rear 214 and/or in addition to the rear 214. For instance, ports may be positioned along other portions of a vertical side wall 220 in part forming and circumscribing the base, where the side wall 220 is best shown in FIG. 3. In addition to or in lieu of the foregoing, ports may be positioned on a top 222 of the base 200, and/or at a portion of the assembly 204.

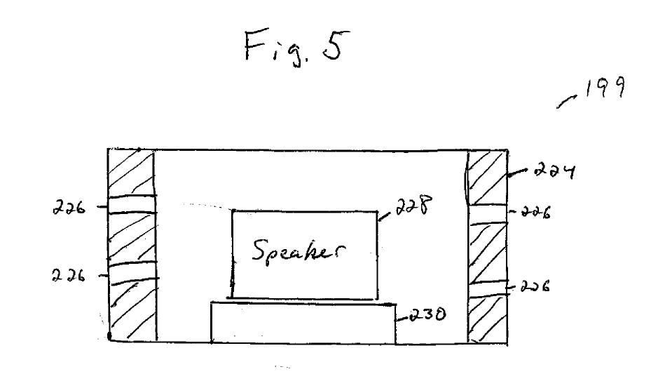

As may be best appreciated from FIGS. 2 and 3, the support assembly 204 (and/or the base 200) includes at least one (e.g. cylindrical) speaker housing 224 formed with vents and/or ports 226 through which air (e.g. and/or sound, sound vibrations, and/or air vibrations) may move and/or travel. The ports 226 may be e.g. perforations in housing 224, and/or ports, holes, apertures, entrances, openings, and/or vents. In any case, as best shown in FIG. 5, it is to be understood that at least one audio speaker 228 is included in and/or on the speaker housing 224 and hence is included in the assembly 204 (and/or base 200). The speaker 228 is further understood to be positioned to direct (and/or emit) sound at least toward and/or through the ports 226.

Still in cross-reference to FIGS. 2-5, at least one duct, tube, and/or pipe 230 may be positioned in the base 200 (and/or support assembly 204). It is to be understood that the duct 230 is positioned to direct air from at and/or around the speaker 228 to and/or through the port(s) 202 whether the ports 202 are in the base 200 and/or a portion of the assembly 204. In the exemplary embodiment shown in FIGS. 2-5, it may be appreciated specifically in reference to FIG. 3 that duct 230 is positioned in the base 200 and positioned to direct air at least laterally relative to the base 200 out of the ports 202.

Without reference to any particular figure, it is to be understood that a base in accordance with present principles, such as the base 200, may define an angular ceiling on a top portion thereof to which e.g. a support assembly such as the assembly 204 may be coupled. Accordingly, rather than defining a horizontal plane orthogonal to a side wall of the base (such as the side wall 220) as may be the case in some embodiments, in other embodiments at least the top portion of the base may be e.g. frustoconical in shape and e.g. oriented with respective cross-sectional diameters being progressively smaller toward e.g. the assembly to which it is coupled, though it is to be further understood in other embodiments such a frustoconical base may be inverted relative to such an orientation.

Also without reference to any particular figure, it is to be understood that in exemplary embodiments, a display base and/or display assembly may be e.g. substantially hollow save for e.g. the components and/or devices disclosed above that may be respectively included therein, thus providing e.g. increased audio amplification capabilities and/or increased quality of sound of audio from a speaker.

Furthermore, note that the one or more speakers described herein may be but are not limited to one or more of the following: tweeters, super tweeters, mid-range speakers, woofers, and subwoofers.

Also note that cables for a display in accordance with present principles such as e.g. power cables, may be routed through the display assembly and/or base in accordance with present principles. In addition to or in lieu of that, e.g. a mounting plate in accordance with present principles may be configured for magnetic and/or snap engagement with a display (e.g. a tablet having a display) and in such embodiments cables need not necessarily be routed through the assembly and/or base.

Further describing speaker housings in accordance with present principles, note that although in exemplary embodiments the speaker housing may by cylindrical, in other embodiments it may be e.g. frustoconical (e.g. when positioned in a frustoconical base and/or assembly), cubic, a rectangular box, parallelepiped, spherical, frustospherical, a hexagonal prism, a square-based pyramid, a triangular-based pyramid, etc. In addition to or in lieu of the foregoing, it is to be understood that e.g. an end and/or portion of a speaker housing in accordance with present principles may be configured such that the end/portion is (e.g. mechanically) coupled (e.g. using a tube, chute, duct, pipe, cylinder, etc. such as the duct 230 described above) to at least one portion of at least one port in the base, thus e.g. allowing air to travel (e.g. directly) from the speaker housing to and/or through the port to which it is connected/coupled without e.g. the air escaping into other portions of a display/speaker assembly.

Furthermore, it is to be generally understood that present principles apply to the manufacturing of e.g. the embodiments described above as well.

Still without reference to any particular figure, note that more than one duct (e.g. such as the duct 230) may be used in an assembly in accordance with present principles, and that plural ducts may even e.g. be positioned to direct air out of ports on (e.g. substantially) opposing portions of the base. Furthermore, the one or more speakers discussed herein are understood to not be limited to the exemplary positioning shown in the figures and may be positioned e.g. in the base 200 rather than assembly 204 in other embodiments.

While the particular AUDIO SPEAKER POSITIONED IN DISPLAY SUPPORT AND/OR BASE is herein shown and described in detail, it is to be understood that the subject matter which is encompassed by the present application is limited only by the claims.

What is claimed is:

1. Apparatus comprising:
a display;
a base formed with at least one port;
a support assembly which connects the display to the base with the display above the base, wherein the support assembly includes a speaker housing formed with ports;
at least one audio speaker in the speaker housing and positioned to direct sound through the ports of the speaker housing; and
at least one tube in the support assembly positioned to direct air to the port in the base.

2. The apparatus of claim 1 wherein the support assembly includes a mounting plate engaged with the display.

3. The apparatus of claim 1, wherein the speaker housing is on the base.

4. The apparatus of claim 1, wherein the display defines a front surface which presents demanded images and the base defines a front which faces the same direction as faced by the front surface of the display and a rear opposed to the front, and wherein the port in the base is in the rear.

5. The apparatus of claim 1, wherein the speaker housing is cylindrical.

6. The apparatus of claim 1, wherein the support assembly includes an upper arm segment pivotably connected to a lower arm segment to raise and lower the display.

7. Assembly comprising:
at least one mounting surface to engage a display;
a base to rest on a surface with the mounting surface above the base;
a support assembly which movably interconnects the base and mounting surface; and
at least one audio speaker positioned in at least one component selected from the group consisting of: the base, and the support assembly.

8. The assembly of claim 7, wherein the speaker is in the support assembly.

9. The assembly of claim 8, further comprising at least one duct in the support assembly positioned to direct air laterally relative to the base.

10. The assembly of claim 8, wherein the support assembly comprises a speaker housing, wherein the speaker is in the speaker housing.

11. The assembly of claim 9, wherein the base is formed with at least one port and the assembly further comprises a speaker housing formed with ports and an audio speaker in the speaker housing is positioned to direct sound through the ports in the speaker housing, and wherein the duct is positioned to direct air through the port in the base.

12. The assembly of claim 11, wherein the speaker housing is on the base.

13. The assembly of claim 7, wherein the mounting surface defines a front surface and the base defines a front which faces the same direction as faced by the front surface of the mounting surface and a rear opposed to the front, and a port is in the rear of the base.

14. The assembly of claim 10, wherein the speaker housing is cylindrical.

15. The assembly of claim 7, wherein the support assembly includes an upper arm segment pivotably connected to a lower arm segment to raise and lower the mounting surface.

16. The assembly of claim 7, comprising a display engaged with the mounting plate.

17. Method comprising:
supporting a display on a movable support assembly above a base to which the support assembly is connected;
providing at least one first port in the support assembly;
providing at least one second port in the base;
providing a source of sound positioned to emit sound directly toward the first port.

18. The method of claim 18, wherein providing the source of sound includes providing a speaker positioned to emit sound directly toward the first port.

19. The method of claim 18, wherein providing at least one first port includes providing plural first ports in the support assembly through which air travels.

20. The method of claim 18, wherein the providing at least one second port includes providing plural second ports in the base.
